(19) United States
(12) Patent Application Publication
(10) Pub. No.: US 2018/0139901 A1
(43) Pub. Date: May 24, 2018

(54) BASE CUTTER BLADE

(71) Applicants: DON RILLO TEKO, BATON ROUGE, LA (US); JARED CORMIER, BATON ROUGE, LA (US)

(72) Inventors: DON RILLO TEKO, BATON ROUGE, LA (US); JARED CORMIER, BATON ROUGE, LA (US)

(21) Appl. No.: 15/844,242

(22) Filed: Dec. 15, 2017

Related U.S. Application Data
(63) Continuation-in-part of application No. PCT/US2016/037892, filed on Jun. 16, 2016.
Application No. PCT/US2016/037892 is a continuation-in-part of application No. 14/740,976, filed on Jun. 16, 2015, now abandoned.

(51) Int. Cl. A01D 34/73; A01D 34/66; A01D 45/10

(52) U.S. Cl. CPC A01D 34/733; A01D 45/10; A01D 34/661

(57) ABSTRACT

An improved base cutter blade suited for use in a sugar cane harvester. The preferred improved blade has a generally elongated flat body with opposing longitudinal edges. A removable, replaceable knife is also provided. The knife is made to releasably engage the leading edge of the body. Thus, the knife will perform most of the cutting work and bear the brunt of the wear suffered by the blade. When the knife becomes dull, only the knife need be replaced, which can be done quickly. This will save a significant amount of time during harvest operations. It will also reduce the amount of material that is consumed in the form of worn out blades.

### PRIORITY STATEMENT

This application claims benefit to and is a continuation-in-part of Patent Cooperation Treaty Application PCT/US2016/37892 (WO2016205532), which claimed benefit to and was a continuation-in-part of U.S. patent application Ser. No. 14/740,976, both of which are hereby incorporated by reference in their entirety.

### BACKGROUND OF THE INVENTION

### Field of the Invention

The invention relates to blades in general and sugar cane base cutter blades in particular.

### Prior Art

Sugar cane is the most widely produced crop in the world, with more than 54 million acres harvested globally in 2007. Much of that cane is harvested using automated harvesters such as that disclosed in Deere & Co.'s U.S. Pat. No. 8,578,688, which is hereby incorporated by reference. As illustrated in FIG. 2 of the '688 patent, the cane is fed into a base cutter assembly that includes a plurality of rotating blades. These blades are usually made of carbon steel, and they are designed to cut the cane near the ground. In addition to the cane, the blades will encounter dirt and debris in the fields—an inevitability given the need to cut the cane low to the ground. Use of the blades will dull the blades. This happens relatively quickly—so quickly, that blades typically must be changed every six hours. This entails stopping the harvester for up to an hour while all blades are removed and replaced. The blades can usually be reversed once, but this does not save time as reversal requires complete removal of the blades. Used blades are usually discarded when replaced, resulting in a significant waste of materials.

Conducting harvesting operations as quickly as possible is important. In much of the world, sugar cane is burned prior to harvesting. Burning expedites harvesting and reduces the amount of low sugar content vegetation that must be handled, shipped, and processed. However, sucrose in the cane will deteriorate quickly after the cane is burned.

Of course, farmers do not intentionally burn more cane than they can harvest promptly. However, equipment breakdowns and adverse weather conditions can prevent good matches between the anticipated rate of harvest and reality. Moreover, in areas where freezing temperatures near harvest are a concern, cane needs to be harvested as soon as it is ready, as sucrose deteriorates rapidly in freeze killed cane as well.

For all of the foregoing reasons, harvest usually runs 24 hours a day until completed. Expediting the rate of harvest when everything is working reduces the chances that the unexpected will have a significant adverse effect on crop yields. However, under current conditions, “everything working” includes shutting down for an hour to change blades every six hours. This represents a scheduled loss of over 10 percent of the harvesting day. In view of the foregoing, a harvester blade meeting the following objectives is desired.

### OBJECTS OF THE INVENTION

It is an object of the invention to provide a harvester blade that does not dull as readily as conventional blades.

It is a further object of the invention to provide a harvester blade that may be changed relatively quickly when the blade becomes dull.

It is a yet another object of the invention to provide a harvester blade that minimizes the material to be discarded or recycled when blades are changed.

It is a still further object of the invention to provide a harvester blade that will expedite the rate at which sugar cane is harvested.

It is yet another object of the invention to minimize the amount of time harvesters are scheduled to be down during harvest.

### SUMMARY OF THE INVENTION

An improved base cutter blade suited for use in a sugar cane harvester is disclosed. The preferred embodiment of the improved blade comprises a generally elongated flat body having opposing longitudinal edges. A removable, replaceable knife is also provided. The knife is configured to releasably engage the leading edge of the body. Grooves are preferably centrally positioned in both edges of the body. In the preferred embodiment, the knife has a slideway engagement with the portion of the groove corresponding to the leading edge of the body. The slideway may be any conventional slideway configuration, including but not limited to a dovetail or a cylindrical configuration. When the knife is in place, the knife will perform most of the cutting work and bear the brunt of the wear suffered by the blade. When the knife becomes dull, only the knife need be replaced, which can be done quickly. This will save a significant amount of time during harvest operations. It will also reduce the amount of material that is consumed in the form of worn out blades. By utilizing harder, more resilient metals for the knife and the body of the blade, the life of both may be extended even further.

### BRIEF DESCRIPTION OF THE DRAWINGS

FIG. 1 is an illustration of a mechanical sugar cane harvester in operation.

FIG. 2 is a perspective view of a prior art sugar cane base cutter plate pair.

FIG. 3 is bottom view of a prior art sugar cane base cutter plate pair.

FIG. 4 is a perspective view of a prior art sugar cane base cutter blade.

FIG. 5 is a perspective view of an embodiment of the improved base cutter body.

FIG. 6 is a perspective view of an embodiment of the improved base cutter knife.

FIG. 7 is an exploded view of an embodiment of the improved base cutter body, knife, and pins.

FIG. 8 is a perspective view of an assembled embodiment of the improved base cutter body, knife, and pins.

FIG. 9 is a bottom view of a sugar cane base cutter plate pair using the embodiment of the improved base cutter blades illustrated in FIG. 8. The “F” in the figure indicates the location of the front of the harvester.

FIG. 10 is an exploded view of an embodiment of the improved base cutter body, knife, and pins illustrating a cylindrical configuration of the slideway.

FIG. 11 is a perspective view of an assembled embodiment of the improved base cutter body, knife, and pins illustrating a cylindrical configuration of the slideway.

FIG. 12 is a close up view of one end of an assembled embodiment of the improved base cutter body, knife, and pins, illustrating a closed end of the slideway.

FIG. 13A is a partially exploded, perspective view of an embodiment of the improved base cutter body, knife and threaded members illustrating a rectangular configuration of the slideway.

FIG. 13B is a partially exploded, perspective view of the embodiment shown in FIG. 13A, illustrating the insertion of the threaded members.

FIG. 13C is a partially exploded, perspective view of the embodiment shown in FIG. 13A, illustrating the threaded members fully inserted.

FIG. 14 is a perspective view of a preferred embodiment of the notched version of cutter blade.

FIG. 15 is an end view of a preferred embodiment of the knife configured for use with the cutter blade shown in FIG. 14.

FIG. 16A is an exploded, perspective view of preferred embodiments of the notched version of the cutter blade, the knives configured for use with the notched version of the cutter blade, and the threaded members used to join the knives to the blade.

FIG. 16B is a perspective view of the preferred embodiments of FIG. 15A shown assembled.

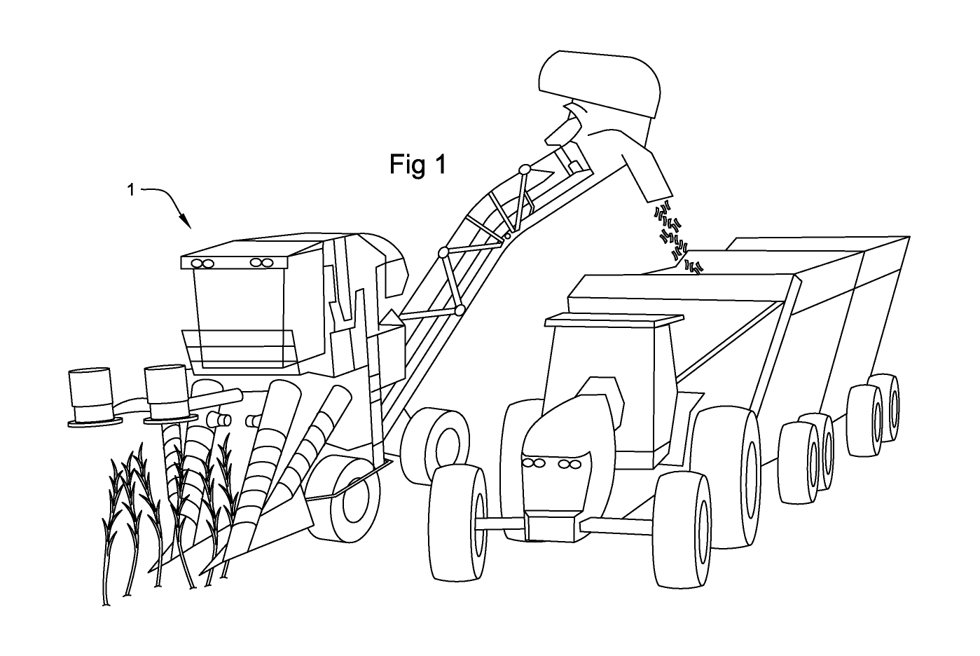

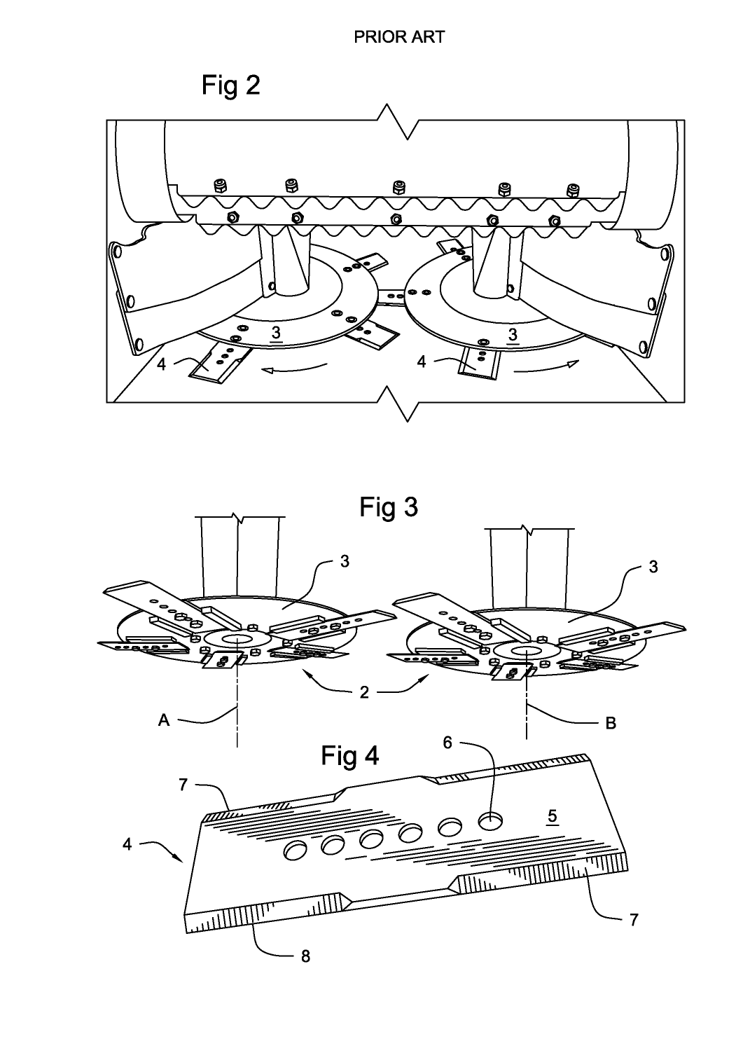

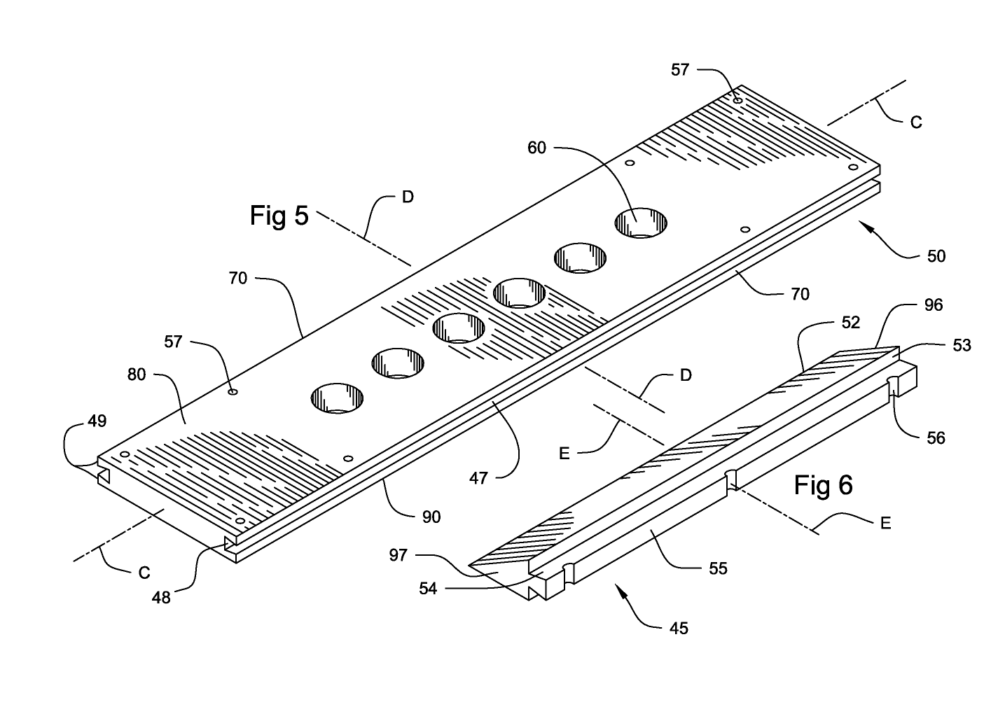

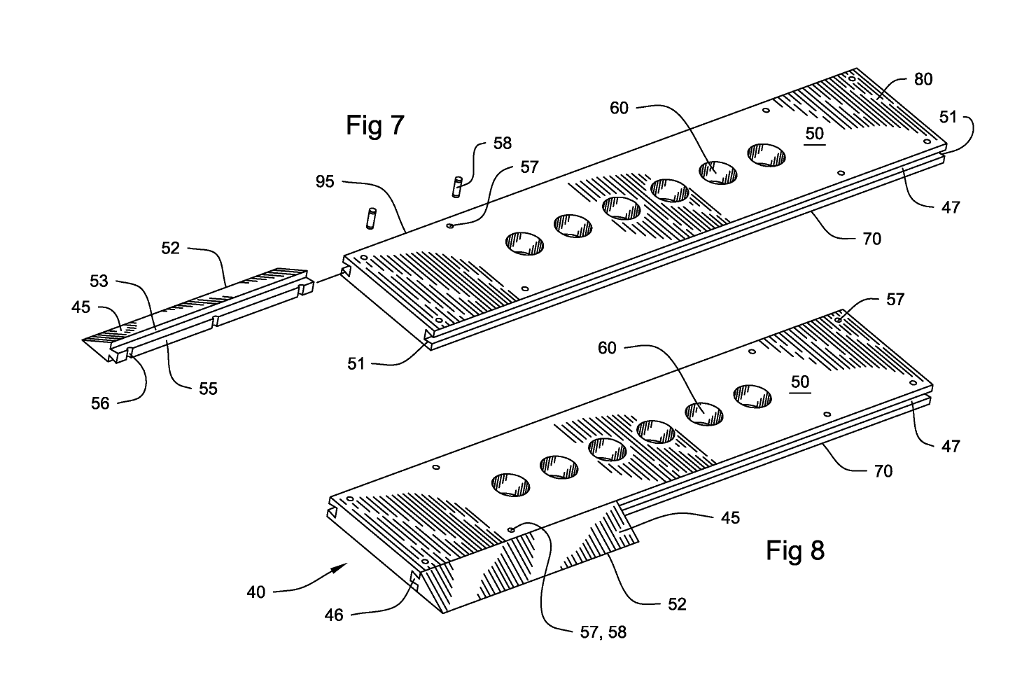

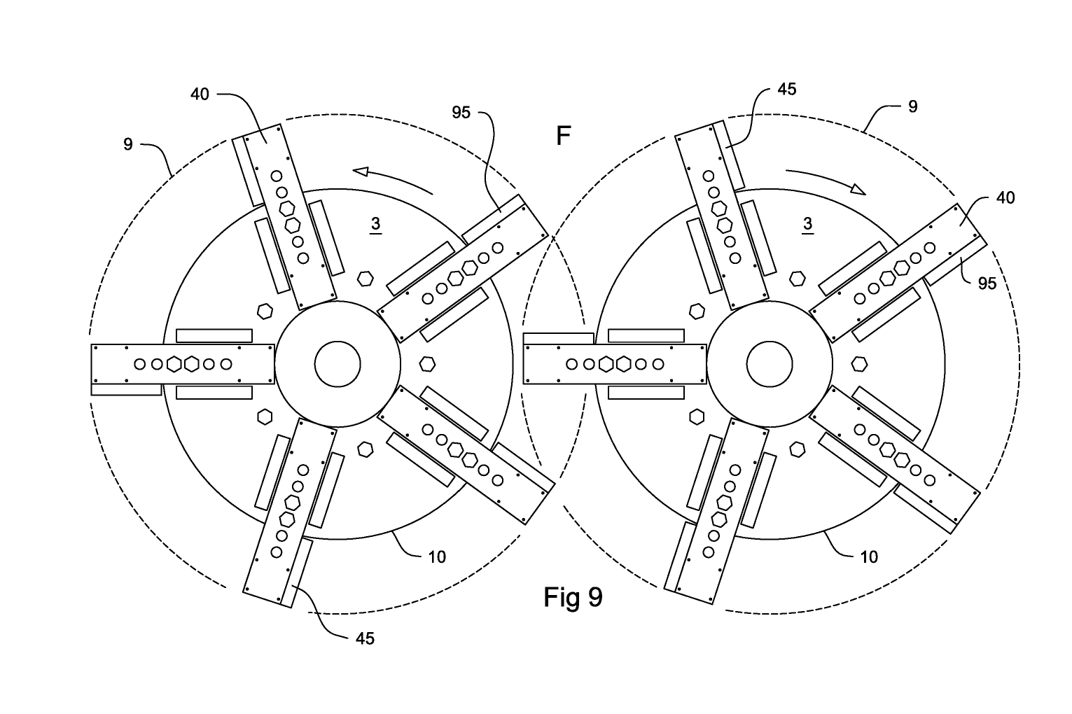

### DETAILED DESCRIPTION OF THE PREFERRED EMBODIMENT OF THE INVENTION

The invention pertains to base cutter blades for sugar cane harvesters. Harvesters 1 typically include one or more pairs 2 of cutting plates 3. Plates 3 are preferably approximately round and each configured to rotate about separate, substantially parallel axes A, B. Plates 3 typically rotate in opposite directions. Each plate 3 is provided with a plurality of base cutter blades 4. Prior art base cutter blades 4 are typically elongated metal bars 5 with a plurality of mounting holes 6 centrally positioned in bars 5. The opposing longitudinal edges 7 of bars 5 are beveled to create a knife edge 8. Base cutter blades 4 are positioned on plates 3 so that blades 4 extend radially from plates 3. When plates 3 are rotated the ends of blades 4 define a circumference 9 that is greater than the circumference 10 of plates 3. Plates 3 are positioned relative to each other so that circumferences 9 of adjacent plates 3 overlap. However, blades 4 are offset relative to each other so that the blades 4 on one plate 3 will not contact their counterpart blades 4 on opposing plate 3 as long as plates 3 rotate at the same rate. Plates 3 may also be slightly offset vertically to ensure blades 4 do not contact during rotation.

The foregoing configuration will sever all cane stalks that come within either circumference 9. However, high speed rotation of base cutter blades 4 will bring them into contact with dirt, rocks, general debris, as well as the cane stalks, which when mature are not exactly tender. Blades 4 are typically mild carbon steel and dull quickly under the foregoing conditions. When dull, blades 4 may be reversed once. Plurality of mounting holes 6 are sized and positioned to facilitate reversal of blades 4 while allowing operators to ensure that the distance blades 4 extend from plates 3 remains constant. However, reversal of blades 4 requires harvester 1 to be stopped and all blades 4 to be removed, reversed, and reinserted. As noted above, this is very time consuming.

Reversing blades 4 converts what was a trailing, shielded edge into the leading edge of blade 4. When the newly exposed edge dulls, the entire prior art blade 4 must be removed and replaced. Removal proceeds in the same manner described above, except instead of reversing blade 4, a new blade 4 is installed. Both processes are equally time intensive.

In theory, blades 4 could be re-sharpened and reused. In practice, blades 4 are usually so worn that re-sharpening is not practical. As a result, blades 4 are usually discarded or recycled.

The preferred embodiment of the invention comprises an improved base cutter blade 40. Like conventional blade 4, improved blade 40 is preferably an elongated metal body 50 having an upper face 80 opposite a lower face 90 and opposing longitudinal edges 70 extending between faces 80, 90. Body 50 is preferably provided with a plurality of centrally located mounting holes 60. Unlike conventional blades 4, edges 70 are not beveled to a knife edge. Rather, edges 70 are configured to receive a releasable and replaceable knife 45, In the preferred embodiment, edges 70 and knife 45 are configured to mate with one another using a slideway 101. In one embodiment, slideway 101 is a dovetail 46. In this embodiment, edges 70 are provided with a centrally positioned groove 47 that preferably runs the length of edge 70. Groove 47 has a base 48 and a mouth 49. Base 48 is preferably wider than mouth 49. At least one and preferably both ends 51 of groove 47 are co-terminal with edge 70 and at least one end 51 is preferably open.

Knife 45 has a cutting edge 52 opposite a base 53. A tail 54 extends from base 53. Tail 54 should match groove 47, in the dovetail embodiment, being slightly narrower where tail 54 joins base 53 and wider at the distal end 55 of tail 54.

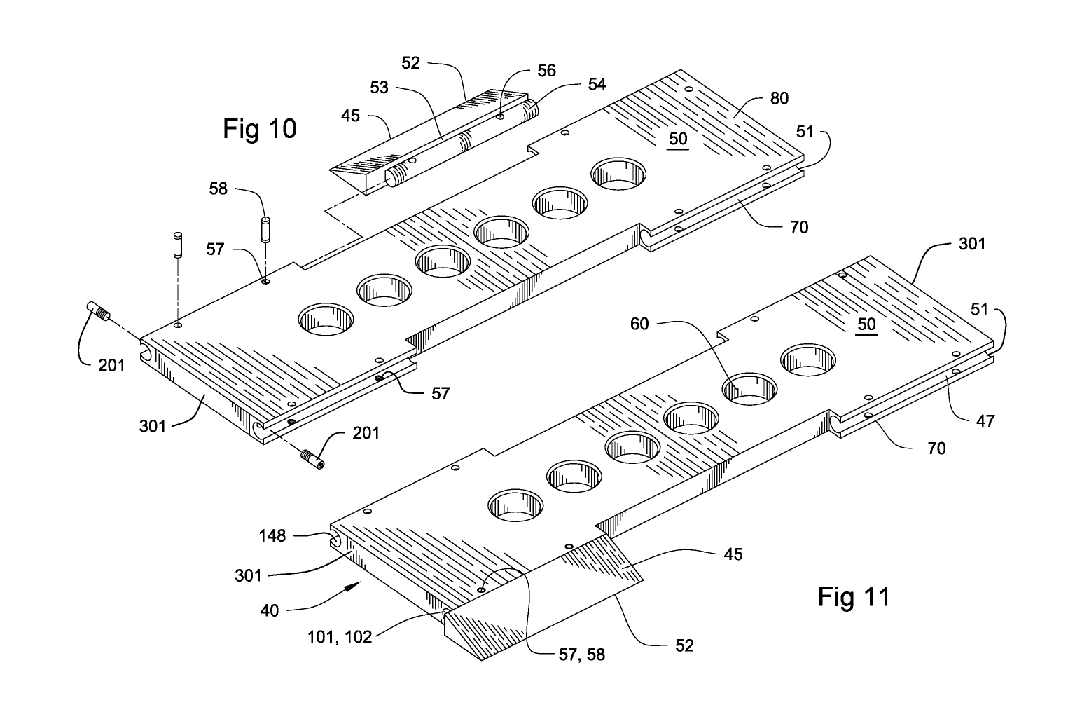

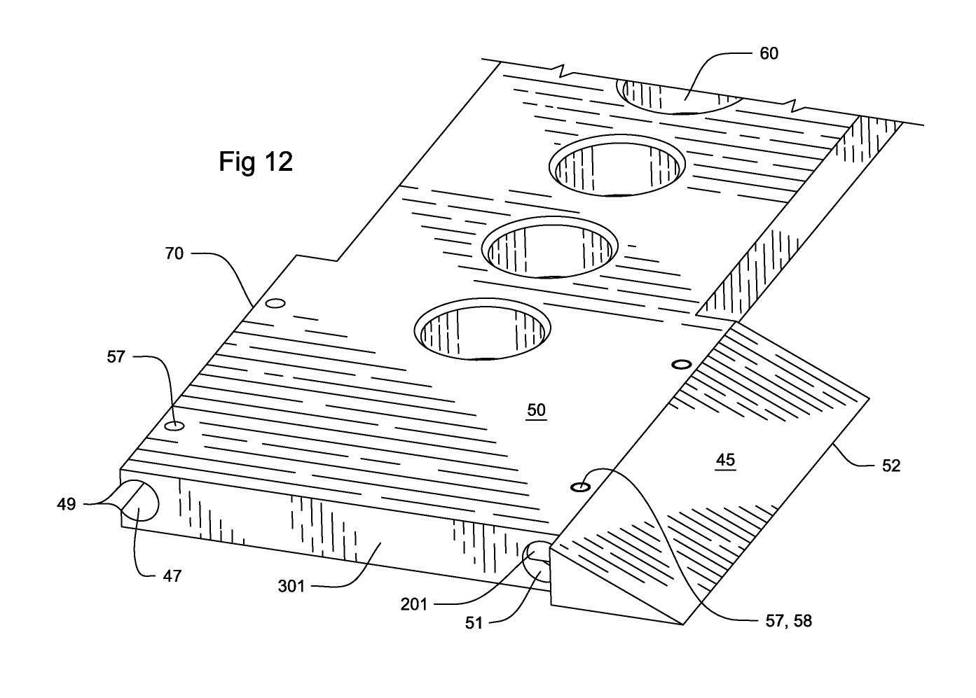

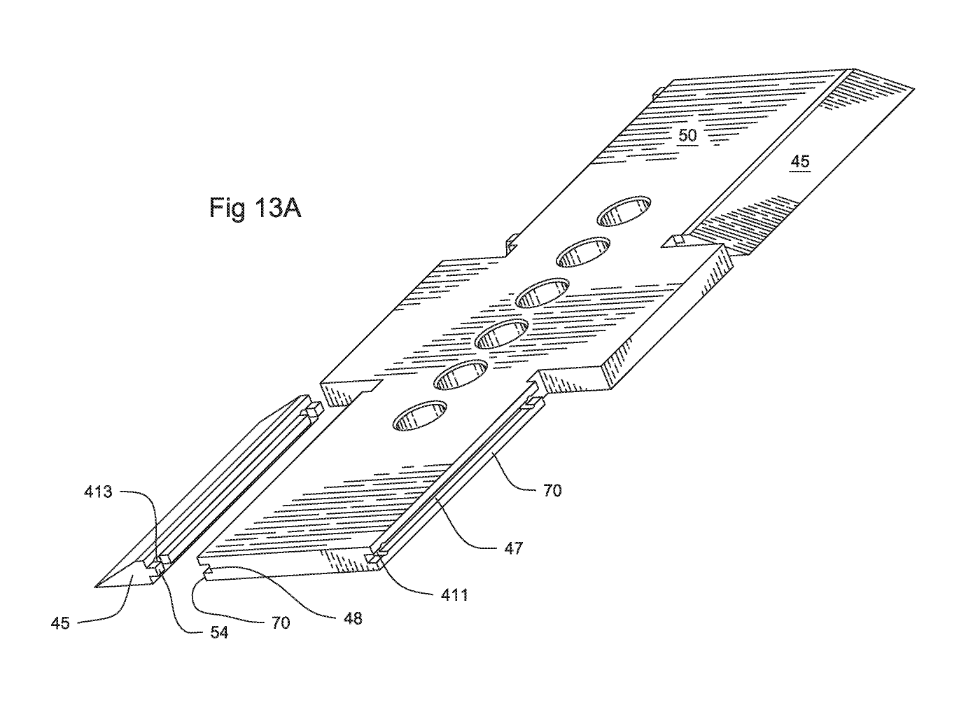

In another embodiment, a different slideway configuration is used. A cylindrical slideway 102 is illustrated in FIGS. 10 and 11. Cylindrical slideway 102 functions similarly to dovetail slideway 46. Edges 70 or segments thereof are configured to receive a releasable and replaceable knife 45. As in the dovetail embodiment, edges 70 and knife 45 are configured to mate with one another using a slideway 101, but in this case a cylindrical slideway 102. As before, edges 70 are provided with a centrally positioned groove 47. Groove 47 comprises a mouth 49 and a channel 148. Channel 148 is preferably wider than mouth 49 and generally circular in cross section, or more accurately, channel 148 has a cross section comprising a fraction of a circle—about ¾ of a circle. At least one and preferably both ends 51 of groove 47 are co-terminal with edge 70 and at least one end 51 is preferably open.

In the cylindrical slideway embodiment, knife 45 has a cutting edge 52 opposite a base 53. A tail 54 extends from base 53. Tail 54 should match groove 47, and is cylindrical, or more accurately, tail 54 is a fraction of a cylinder, about ¾ of a cylinder in the embodiment depicted, though important thing is that the dimensions of tail 54 match groove 47. In this embodiment, tail 54 should be narrower where tail 54 joins base 53 than the widest portions of tail 54.

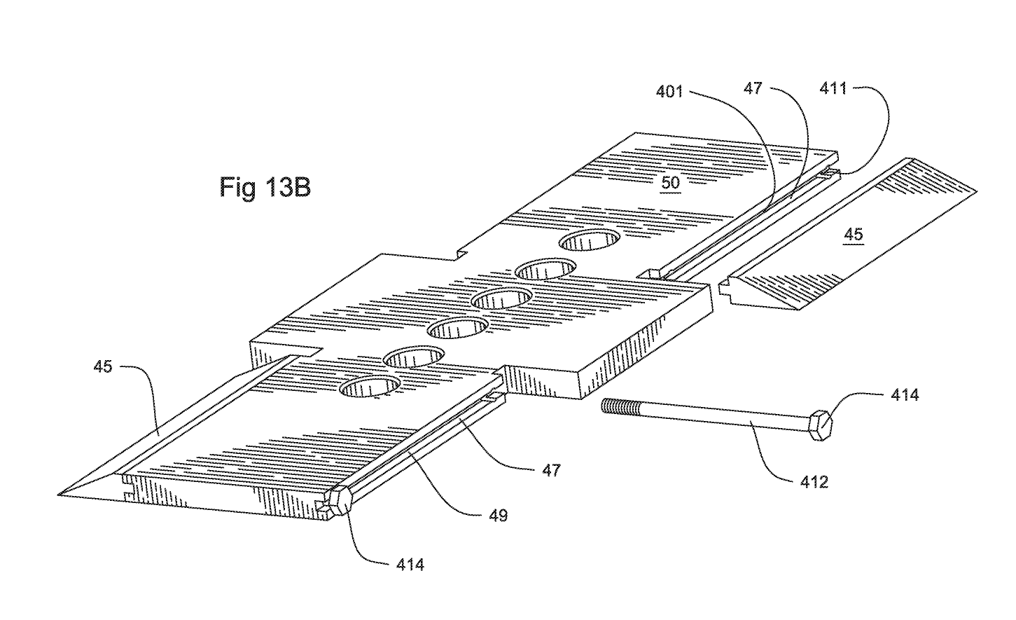

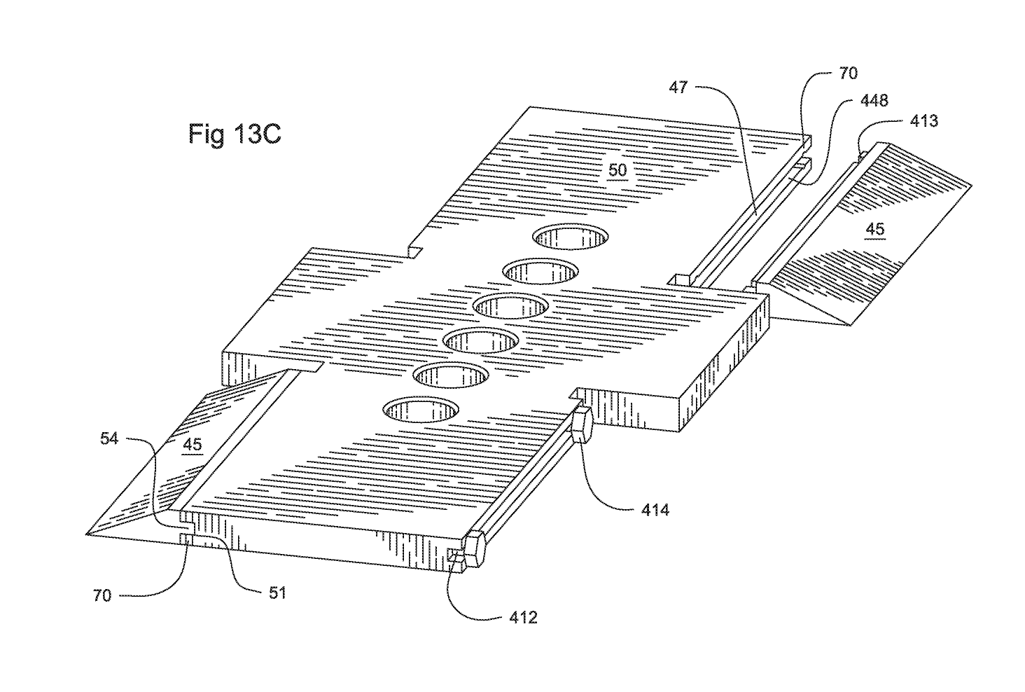

In yet another embodiment, still another slideway configuration is used. In this configuration, illustrated in FIGS. 13A-13C, slideway 401 functions similarly to dovetail slideway 46. Edges 70 or segments thereof are configured to receive a releasable and replaceable knife 45. As in the dovetail embodiment, edges 70 and knife 45 are configured to mate with one another using a slideway 401. As before, edges 70 are provided with a centrally positioned groove 47. Groove 47 comprises a mouth 49 and a base 48 and a channel 448. Channel 448 is preferably of a uniform width between mouth 49 and base 48 generally rectangular in cross section, or more accurately, channel 448 has a cross section comprising a fraction of a rectangle—three sides of a rectangle, but with an open face at mouth 49.

In the preferred embodiment shown in FIGS. 13A-13C, one end 51 of groove 47 is co-terminal with edge 70 and that end 51 is open. However, it will be appreciated that because groove 47 has a uniform cross section, end 51 of groove 47 could be closed. In this embodiment, tail 54 of knife 45 could be inserted transverse to groove 47, instead of sliding tail 54 along slideway 401. Though insertion along slideway 401 will be assumed in the discussion below, those skilled in the art will appreciate that this means of insertion is not exclusive in the embodiment shown in FIGS. 13A-13C.

Whichever version of the slideway is used, knife 45 may be joined with body 50 by inserting tail 54 into groove 47 at open end 51. Tail 54 is preferably provided with a plurality of channels 56 which may pass through tail 54 or create slots in distal end 55 of tail 54. Body 50 is provided with a plurality of apertures 57 that open onto groove 47 and align with channels 56 in tail 54 when tail 54 has been inserted into groove 47. A plurality of pins 58 are preferably provided. Pins 58 are sized to mate with apertures 57 and channels 56 and are preferably coiled or slotted spring pins. By inserting pins 58 into apertures 57 and channels 56, knife 45 and tail 54 may be secured to body 50 and groove 47. In particular, the slideway connection between tail 54 and groove 47 will secure knife 45 to body 50 in directions perpendicular to edge 70 and pins 58 will secure knife 45 in the direction parallel to edge 70—i.e., pins 58 will prevent knife 45 from sliding within groove 47.

In the embodiment shown in FIGS. 13A-13C, body 50 is provided with one or more passages 411. Passages 411 extend from one edge 70, across body 50, to opposite edge 70. Passages 411 are sized to provide passage to a threaded member 412, such as a bolt. Knife 45 preferably contains one or more mated inserts 413, sized to receive and engage threaded member 412. Mated inserts 413 are preferably contained within tail 54. Preferably, mated openings 413 will be internally threaded to engage the external threads of threaded member 412. It will be appreciated that while inserts 413 may be literally added to knife 45, the term “insert” is also intended to cover a threaded opening that is cut, milled, or cast into knife 45, so that rather than being added to knife 45, the “insert” is formed within knife 45. By passing threaded member 412 through passage 411 and threading member 412 into mated insert 413, knife 45 may be secured to body 50. When it is desirable to remove knife 45, threaded members 412 need only be reversed, and knife 45 may removed from the slideway linearly or transversely. This method of attachment will allow knives 45 to be switched quickly with a wrench or drill fitted with a socket. The wrench or socket may use a nut driver head, a torque or hex head, a Phillips or slotted screw driver head, or any other conventional rotational driver. The connection between knife 45 and body 50 can be secured tightly by adequately torquing threaded member 412. The control end 414 of threaded member 412 will be protected by being on the protected or trailing edge of body 50.

In a preferred embodiment, one end 51 of groove 47 is preferably closed. The end 51 that is closed is preferably the end 51 proximate to ends 301 of body 50. In one embodiment, one end 51 of groove 47 is closed with a stop 201. In one embodiment, stop 201 is a screw that is threaded into base 48 of groove 47. Stop 201 will prevent passage of tail 54 within groove 47. By positioning stop 201 and sizing tail 54 appropriately, apertures 57 and channels 56 will be aligned when tail 54 encounters stop 201.

Closing an end 51 of groove 47 will also help secure and retain knife 45 in body 50. During operation, knife 45 will be subjected to centrifugal forces due to the rotation of body 50. If knife 45 is not restrained, these forces would tend to sling knife 45 from body 50, potentially damaging equipment or injuring persons in the vicinity. Pins 58 will secure knife 45 to body 50. However, if pins 58 should fail or if workers should fail to insert pins 58 properly, centrifugal discharge of knife 45 may be prevented by closing end 51 of groove 47 proximate end 301 of body 50.

In a preferred embodiment, base 53 of knife 45 is longer than, or at least offset relative to, tail 54. By sizing knife 45 and tail 54 appropriately, base 53 of knife 45 will extend beyond the end of body 50. In a preferred embodiment, knife 45 will extend beyond body 50 by about ½ inch. This will allow knife 45 to shield body 50 and especially the entry to groove 47 during operation.

When knives 45 become dull, rather than removing and changing blades 40, pins 58 may be removed and only knives 45 need be changed. A task that previously required an hour can be reduced to 10 to 15 minutes.

In the preferred embodiment, knives 45 will be about four inches long or slightly longer. During use, most of the wear will be confined to the forward two inches of knife 45. By positioning channels 56 properly, knife 45 may be reversed—turned 180 degrees about axis E—so that its rearward end 96 becomes the forward end 97. When it is desired that knife 45 be reversible, knife 45 will preferably be generally symmetrical about axis E. Making knives 45 reversible will effectively double the life of each knife 45 and minimize the waste associated with blades 40.

In a preferred embodiment, groove 47 extends the length of both edges 70. However, it will be appreciated that groove 47 could be limited to the length of knife 45 or some fraction of edge 70. Groove 47 could also be provided on only one edge of body 50. There are advantages to positioning grooves 47 on both sides of body 50. It will be appreciated that the leading edge 95 of body 50—where knife 45 is positioned—will be subjected to the majority of wear. However, because of the proximity of plate 3 and blade 40 to the ground and the general operating conditions to which blade 40 will be exposed, some wear on edge 70 is inevitable. If groove 47 becomes worn so that a new knife 45 cannot be readily inserted or secured, body 50 may be removed and reversed in the same fashion as prior art blades 4, which will allow the opposite and previously sheltered end of groove 47 to become leading edge 95 of body 50. This portion of edge 70 should be relatively undamaged and able to receive knife 45. However, reversal is only practical if grooves 47 are on both edges 70.

By positioning grooves 47 along the longitudinal center of edges 70, it will be appreciated that body 50 may be rotated about two of its axes C, D to present any of the four corners of body 50 as the leading edge of body 50. That is, body 50 is fully reversible. In each position, body 50 can receive knife 45 and every corner of edge 70 may be the leading edge depending upon the orientation of body 50.

The foregoing configuration will significantly enhance the life of blades 40. Knives 45 will bear the brunt of the wear to which blades 40 will be exposed. Knives 45 may be easily and quickly reversed or replaced. However, when the leading groove 47 of body 50 becomes damaged, body 50 may flipped at least once and, depending upon the nature and extent of the wear, as many as three times before body 50 must be replaced.

In another embodiment, blades 40 are provided with notches 501. Notches 501 are configured to receive knives 45. In the preferred embodiment, notch 501 is formed by removing rectangular segments from opposite corners of blades 40. Each notch 501 will preferably have a mounting edge 502A parallel to edge 70. In a preferred embodiment, mounting edge 502A is provided with a half lap edge 503A. The formation of half lap edge 503A will create a shoulder 506 within notch 501, and a support shelf 509 will extend substantially transverse to shoulder 506. Half lap edge 503A is preferably provided with a plurality of mounting apertures 504A.

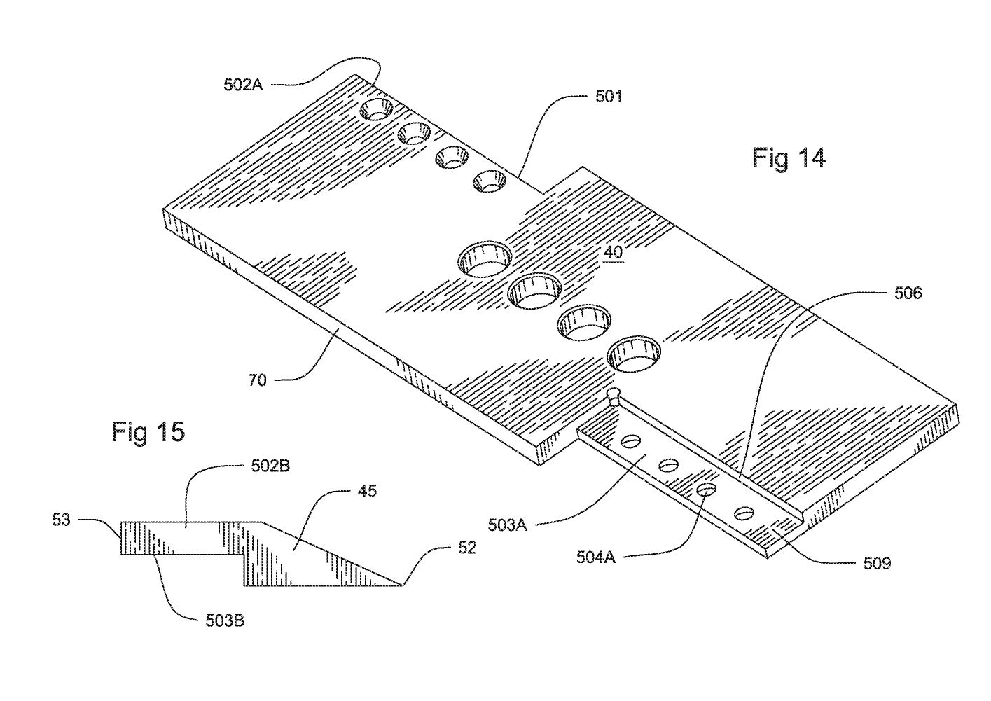

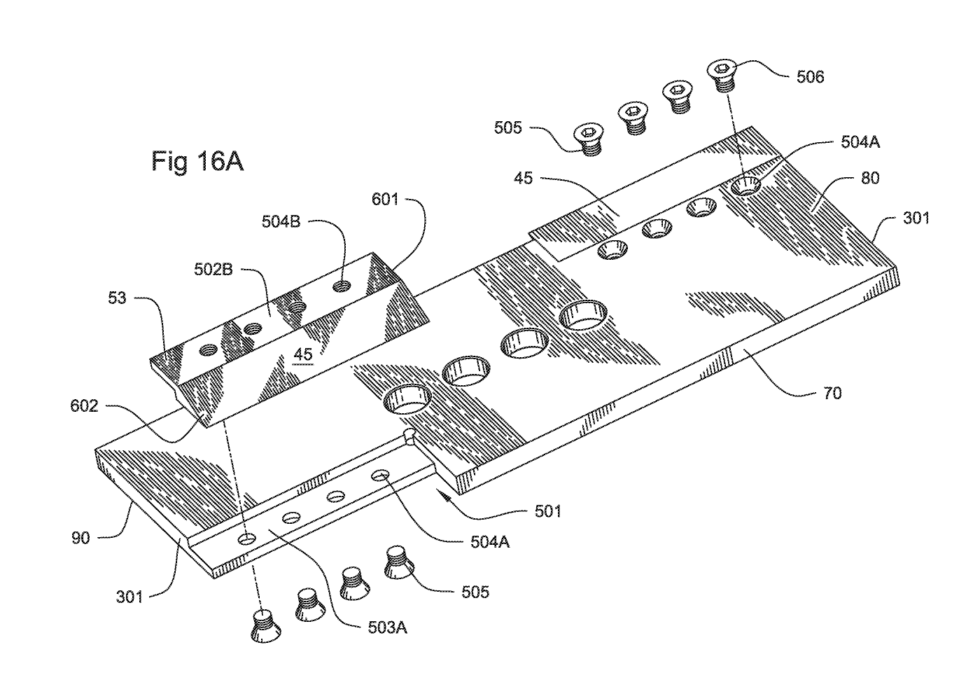

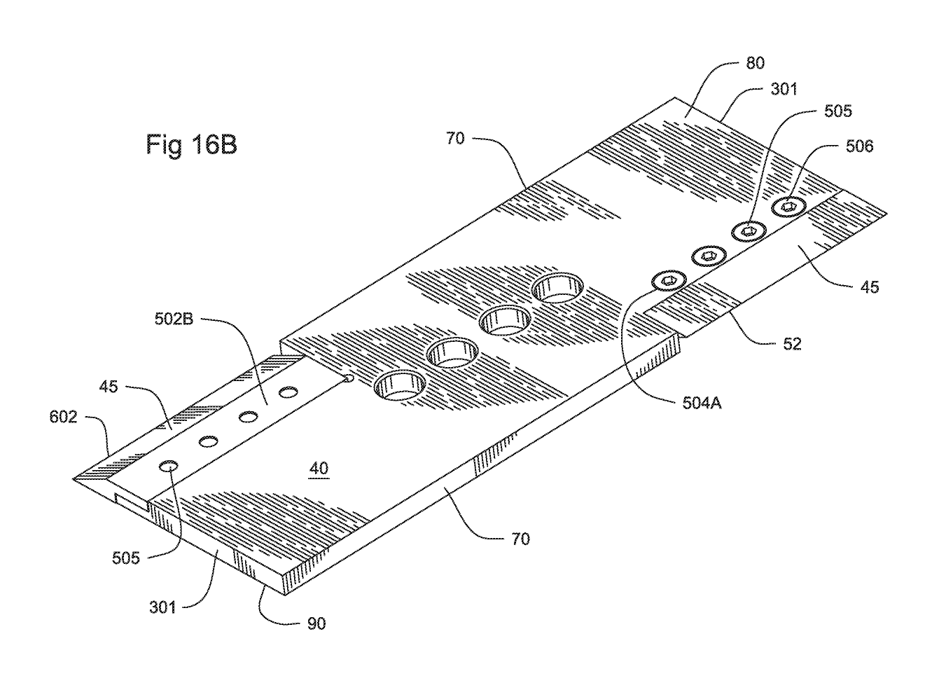

In this embodiment, illustrated in FIGS. 14-16B, knife 45 has a cutting edge 52 opposite a base 53. However, base 53 comprises a mounting edge 502B configured to mate with mounting edge 502A. In the preferred embodiment mounting edge 502B of knife 45 is provided with a half lap edge 503B that mirrors half lap edge 503A. This allows knife 45 to fit snugly into notch 501, with base 53 adjacent to shoulder 506. The impacts experienced by knife 45 during cutting operations will be spread across notch 501 and shoulder 506, instead of being born by fasteners 505 (discussed below). This configuration also allows knife 45, and especially cutting edge 52, to be within the same plane as blade 40. This will protect knife 45 during operation.

Mounting edge 502B is also preferably provided with a plurality of mounting apertures 504B positioned to align with mounting apertures 504A when knife 45 is in place in notch 501. At least one of mounting apertures 504A, 504B is preferably provided with internal threads. In the embodiment illustrated, the threads are in mounting apertures 504B in knife 45. The other mounting apertures, apertures 504A in the drawings, are preferably oversized. This allows an externally threaded fastener 505, such as a bolt, to join knife 45 to blade 40. In the preferred embodiment threaded fastener will have a control end 506. Control end 506 will preferably be sized appropriately to fit into oversized aperture 504A, 504B but be too large to pass through that aperture. This will allow fastener 505 to be tightened and for control end 506 to snug against the walls of aperture 504A, 504B. The desired amount of torque can be applied to fastener 505 and control end 506 will be protected by aperture 504A, 504B during cutting operations. Any conventional rotational head can be used on control end 506, and a matching driver can be used to tighten and loosen fastener 505 in the same manner discussed above with regard to threaded member 412.

In a preferred embodiment, notches 501 are placed on opposite faces 80, 90 of blade 40. This allows knives 45 in each notch 501 to be oriented 180 degrees relative to each other. That is, one knife 45 will be upside down relative to the other. This will facilitate reversal of knives 45. In operation, the ends of knives 45 closest to ends 301 of blades 40 will incur most of the wear. By orienting notches 501 on opposite faces 80, 90 of blade 40, the interior 601 and exterior 602 ends of each knife 45 will be reversed when knife 45 is moved from one notch 501 to the other. Thus, when it is time to change knives 45, operators may invert blades 40. This will convert a trailing, protected edge to a leading edge. If the blade is equipped with two knives 45, the inverted blade 50 will be ready to cut. However, if the rear notch 501 is empty or if the knife 45 in the now forward slot becomes dull, the operator may swap the front knife 45 with the back. This will cause the interior ends 601 of each knife 45 to become the exterior ends 602. This will allow each knife 45 to be used twice before resharpening or replacement is required.

All of the foregoing advantages may be achieved utilizing bodies 50 and knives 45 made of carbon steel—the same materials from which prior art blades 4 are commonly made. However, the life of blades 40 and knives 45 may be extended significantly by using higher quality metals for each component. The improved design facilitates this, as the part taking the most abuse, knife 45, is relatively small. Using higher quality and correspondingly more expensive material is more economically feasible when only a small component is discarded when replacement becomes necessary.

In the preferred embodiment, knife 45 is made from CPM 10V (AISI A11) tool steel. The preferred alloy is manufactured via Crucible Particle Metallurgy™ by Crucible Industries, Inc. It includes high carbon and vanadium to provide good wear resistance, toughness, and strength. Knife 45 is preferably formed from a solid block of metal via computerized numerical control (CNC) machining. Once knife 45 is formed, it is preferably age hardened to increase its hardness to at least about 60 on the HRC Rockwell scale. The resulting knife 45 can be expected to operate for at least about 24 hours under extreme harvest conditions before a new knife 45 is required.

Body 50 is preferably made of a high strength alloy capable of withstanding cyclic loading of the kind commonly encountered during harvest. Suitable alloys include AISI 4130 steel. Body 50 is also preferably cut from a solid block of metal using CNC machining. Once formed, body 50 will preferably be age hardened until its Rockwell HRC number is at least about 45. The resulting body 50 will hold up well under harvest conditions commonly faced by harvester 1.

In operation, blades 40, including knives 45, will be installed on plates 3. Harvester 1 will be operated in the same manner as it was with prior art base cutter blades 4. When knives 45 become dull, harvester 1 will be stopped, pins 58, when present, will be removed, and knives 45 will be reversed or replaced. This will be much faster than replacing blades 4. Once knives 45 have been reversed or new knives 45 have been installed, harvest operations may resume.

Although the invention has been described in the context of sugar cane base cutter blades, it will be appreciated that base cutter blades 40 could be used to cut any crop, weed, or other vegetation. These and other improvements to the base cutter blades will be apparent to those of skill in the art from the foregoing disclosure and drawings and are intended to be encompassed by the scope and spirit of the following claims.

I claim:

1. A base cutter assembly comprising a plate configured to rotate about a central axis and a plurality of base cutter blades extending radially from said plate, at least one of said blades comprising:
an elongated body having an upper surface opposite a lower surface and a pair of opposing longitudinal edges extending between said upper surface and said lower surface wherein one of said edges comprises a leading edge of said blade when said plate is rotated about said axis; and
a knife configured to releasably engage said leading edge of said blade, whereby said knife may be removed and replaced without replacing said body.

2. A base cutter assembly according to claim 1 wherein said knife has a cutting edge opposite a base.

3. A base cutter assembly according to claim 2 wherein said knife further comprise a tail extending from said base.

4. A base cutter assembly according to claim 3 wherein said leading edge of said blade comprises a groove having a base and a mouth.

5. A base cutter assembly according to claim 4 wherein said groove is sized to receive said tail.

6. A base cutter assembly according to claim 5 wherein said groove is a slideway.

7. A base cutter assembly according to claim 3 wherein said pair of opposing edges each comprise a groove having a base and a mouth.

8. A base cutter assembly according to claim 7 wherein each said groove is sized to receive said tail.

9. A base cutter assembly according to claim 8 wherein each said groove is positioned in about the longitudinal center of each edge.

10. A base cutter assembly according to claim 9 wherein said groove is a dovetail slideway.

11. A base cutter assembly according to claim 9 wherein said groove is a slideway having a cross section comprising a fraction of a circle.

12. A base cutter assembly according to claim 9 wherein said groove is a slideway having a cross section comprising a fraction of a rectangle.

13. A base cutter assembly according to claim 1 wherein said knife is age hardened to at least about 60 on the HRC Rockwell scale.

14. A base cutter assembly according to claim 13 wherein said body is age hardened to at least about 45 on the HRC Rockwell scale.

15. A base cutter assembly according to claim 1 wherein said body is further provided with a plurality of mounting holes.

16. A base cutter assembly according to claim 6 further comprising at least two plates, each said plate configured to rotate about separate, substantially parallel central axes and a plurality of base cutter blades extending radially from each said plate.

17. A base cutter assembly according to claim 16 where said at least two plates are configured to rotate in opposite directions.

18. A base cutter assembly according to claim 17 wherein said base cutter assembly is positioned in a sugar cane harvester.

19. A base cutter assembly according to claim 6 wherein said knife is reversible.

20. A base cutter assembly according to claim 5 wherein said blade further comprises at least one passageway extending through said body between said longitudinal edges and wherein said knife contains at least one internally threaded insert positioned to align with said passageway when said knife is engaged with said blade, whereby said knife may be secured to said blade with an externally threaded bolt sized to mate with said internally threaded insert and positioned within said passageway.

21. A base cutter assembly according to claim 2 further comprising at least one pair of mounting apertures, wherein said leading edge of said blade contains one aperture of said pair of mounting apertures and wherein said knife contains the other aperture of said pair of mounting apertures, wherein said mounting apertures are positioned on their respective blade and knife to align said pair of mounting apertures when said knife is installed on said blade, and wherein at least one of said mounting apertures comprising said pair of mounting apertures is internally threaded, whereby said knife may be secured to said blade by threading an externally threaded fastener through said pair of mounting apertures.

22. A base cutter assembly according to claim 21 wherein said base of said knife is provided with a half lap mounting edge and wherein said leading edge of said blade is provided with a corresponding half lap mounting edge, whereby said knife and said blade may be joined to align said knife with said blade body.

23. A base cutter assembly according to claim 22 wherein said half lap mounting edges are configured to position said base of said knife adjacent to a shoulder on said blade body when knife is secure to said blade.

24. A base cutter assembly according to claim 2 wherein said blade is reversible and whereby reversal of said blade will convert opposing edges of said blade into leading edges of said blade, wherein one leading edge is provided with a half lap mounting edge comprising a shoulder depending from said upper face and a support shelf extending substantially transverse to said shoulder; and wherein said other leading edge is provided with a second half lap mounting edge comprising a shoulder depending from said lower face and a support shelf extending substantially transverse to said shoulder.
